(19) United States
(12) Patent Application Publication
(10) Pub. No.: US 2026/0246207 A1
(43) Pub. Date: Aug. 20, 2026

(54) BOARD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yu KATO, Osaka (JP); Takuya OKAMOTO, Osaka (JP)

(21) Appl. No.: 19/489,593

(22) PCT Filed: Jun. 4, 2024
(86) PCT No.: PCT/JP2024/020331

§ 371 Date: Dec. 3, 2025

(30) Foreign Application Priority Data
Jun. 7, 2023 (JP) 2023-093874

(51) Int. Cl. H01R 13/6585; H01R 12/70; H01R 13/6598

(52) U.S. Cl. CPC H01R 13/6585; H01R 12/7076; H01R 13/6598

(57) ABSTRACT

The present invention achieves both impedance matching and prevention of fitting of another member into a gate-shaped part. A substrate connector (A) comprises an inner conductor (10) to be connected to a circuit substrate (P), a dielectric body (20) accommodating the inner conductor (10), and an outer conductor (30) surrounding the dielectric body (20). The outer conductor (30) has a hood part (31) surrounding a front-end part of the inner conductor (10), and a gate-shaped part (33) disposed over an area rearward of the inner conductor (10) and the dielectric body (20), the gate-shaped part (33) having an open rear surface and an open lower surface opposing the circuit substrate (P). An upper rib (40) and a lower rib (41) are formed on an inner surface of at least one side wall part (36) of left and right side wall parts (36) constituting the gate-shaped part (33). A minimum opposing interval (W3) of a pair of side wall parts (36) including the upper rib (40) and the lower rib (41) is smaller than a width dimension (W2) of the hood part (31).

### TECHNICAL FIELD

The present disclosure relates to a board connector.

### BACKGROUND

Patent Document 1 discloses a board connector including an outer conductor. The outer conductor includes a gate-shaped dielectric surrounding portion with open lower and rear surfaces and a tube portion extending forward from the dielectric surrounding portion. The dielectric surrounding portion is fixed to a circuit board. A dielectric holding an inner conductor is accommodated in the dielectric surrounding portion. A board connecting portion of the inner conductor is exposed to the outside of the dielectric behind the dielectric and arranged in the dielectric surrounding portion. The dielectric surrounding portion includes a gate-shaped portion located behind the dielectric and the inner conductor. The gate-shaped portion functions to shield noise to the inner conductor.

### PRIOR ART DOCUMENT

### Patent Document

Patent Document 1: JP 2023-017423 A

### SUMMARY OF THE INVENTION

### Problems to be Solved

Since the gate-shaped portion is a part made of metal, an impedance may become lower than in other regions. As a countermeasure against this, it is thought to perform impedance matching by widening an interval between a pair of side walls constituting the gate-shaped portion. However, if the interval between the side walls of the gate-shaped portion is widened, a tube portion of another outer conductor may be fit into the gate-shaped portion of the outer conductor, for example, when a multitude of outer conductors are conveyed in a bagged state if this interval becomes larger than a width of the tube portion of the outer conductor.

A board connector of the present disclosure was completed on the basis of the above situation and aims to realize both impedance matching and the fit-in prevention of another member into a gate-shaped portion.

### Means to Solve the Problem

The present disclosure is directed to a board connector with an inner conductor to be connected to a circuit board, a dielectric for accommodating the inner conductor, and an outer conductor for surrounding the dielectric, the outer conductor including a receptacle for surrounding a front end part of the inner conductor and a gate-shaped portion to be arranged over a range behind the inner conductor and the dielectric, the gate-shaped portion being such that a rear surface and a lower surface facing the circuit board are open, a rib being formed on an inner surface of at least one of both left and right side wall portions constituting the gate-shaped portion, and a minimum facing interval between the pair of side wall portions including the rib being smaller than a width of the receptacle.

### Effect of the Invention

According to the present disclosure, it is possible to realize both impedance matching and the fit-in prevention of another member into a gate-shaped portion.

### BRIEF DESCRIPTION OF THE DRAWINGS

FIG. 1 is a perspective view of a board connector of an embodiment when viewed obliquely from a lower front side.

FIG. 2 is a perspective view of the board connector shown in FIG. 1 when viewed obliquely from a lower rear side.

FIG. 3 is a perspective view showing the board connector shown in FIG. 1 in a disassembled state when viewed obliquely from the lower rear side.

FIG. 4 is a side view in section of the board connector shown in FIG. 1.

FIG. 5 is a plan view in section of the board connector shown in FIG. 1.

FIG. 6 is a back view of the board connector shown in FIG. 1.

### DETAILED DESCRIPTION TO EXECUTE THE INVENTION

### Description of Embodiments of Present Disclosure

First, embodiments of the present disclosure are listed and described. Arbitrary combinations of a plurality of the following embodiments without causing any contradiction are also included in modes for carrying out the invention.
(1) The board connector of the present disclosure is provided with an inner conductor to be connected to a circuit board, a dielectric for accommodating the inner conductor, and an outer conductor for surrounding the dielectric, the outer conductor including a receptacle for surrounding a front end part of the inner conductor and a gate-shaped portion to be arranged over a range behind the inner conductor and the dielectric, the gate-shaped portion being such that a rear surface and a lower surface facing the circuit board are open, a rib being formed on an inner surface of at least one of both left and right side wall portions constituting the gate-shaped portion, and a minimum facing interval between the pair of side wall portions including the rib being smaller than a width of the receptacle. According to the configuration of the present disclosure, since the minimum facing interval between the pair of side wall portions including the rib is smaller than the width of the receptacle, it can be suppressed that the receptacle is fit into the gate-shaped portion. Since a maximum interval between the pair of side wall portions can be enlarged by forming the rib, impedance matching can be performed by suppressing a reduction in impedance.
(2) Preferably, in (1), an accommodation space open rearward to accommodate the dielectric is formed in a region in front of the gate-shaped portion in the outer conductor, and the rib is formed with a guide surface for guiding the dielectric in a process of inserting the dielectric into the accommodation space. According to this configuration, workability in inserting the dielectric into the accommodation space is improved.
(3) Preferably, in (1) or (2), a board connecting portion to be connected to the circuit board, out of the inner conductor, is exposed while extending thin and long in a vertical direction in a rear surface of the dielectric, and the rib is arranged only at a height near an upper end part or a lower end part of the board connecting portion. According to this configuration, impedance mismatching due to the formation of the rib can be suppressed. That is, concerning the position of the rib in the vertical direction, the height near the upper end part or the lower end part of the board connecting portion is a height at which a reduction in impedance is hardly caused by the rib near the upper end part or the lower end part of the board connecting portion.
(4) Preferably, in (1) or (2), a board connecting portion to be connected to the circuit board, out of the inner conductor, is exposed while extending thin and long in a vertical direction in a rear surface of the dielectric, a wide portion having a larger width than the both upper and lower end parts is formed in an intermediate region between the both upper and lower end parts of the board connecting portion, out of the board connecting portion, and the rib is arranged at a height different from the wide portion in the vertical direction. According to this configuration, impedance mismatching due to the formation of the rib can be suppressed.

### Details of Embodiment of Present Disclosure

### Embodiment

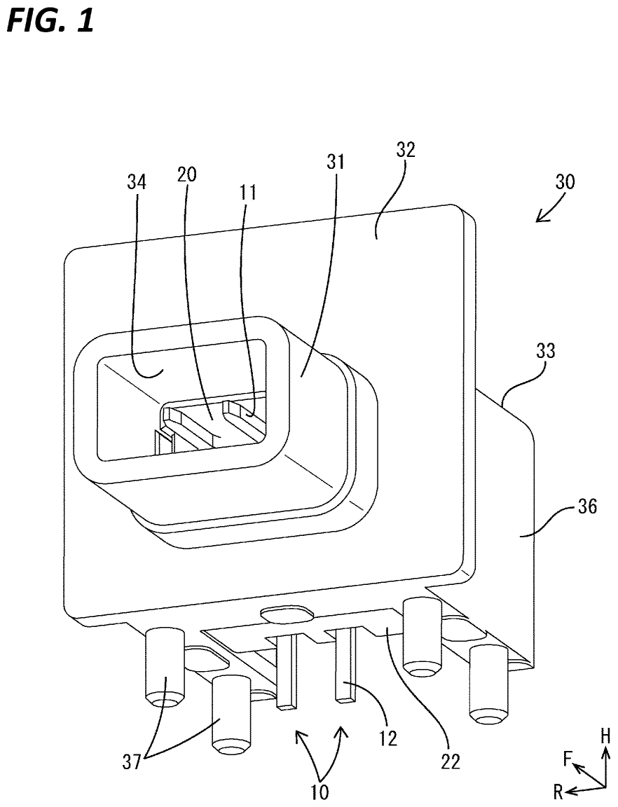

A board connector A of a specific embodiment of the present disclosure is described with reference to FIGS. 1 to 6. The present invention is not limited to these illustrations, but is represented by claims and intended to include all changes in the scope of claims and in the meaning and scope of equivalents. In this embodiment, a direction F in FIGS. 1 to 5 is defined as a forward direction concerning a front-rear direction. A direction H in FIGS. 1 to 4 and 6 is defined as an upward direction concerning a vertical direction. A direction R in FIGS. 1 to 3, 5 and 6 is defined as a rightward direction concerning a lateral direction. The lateral direction and a width direction are used as synonyms.

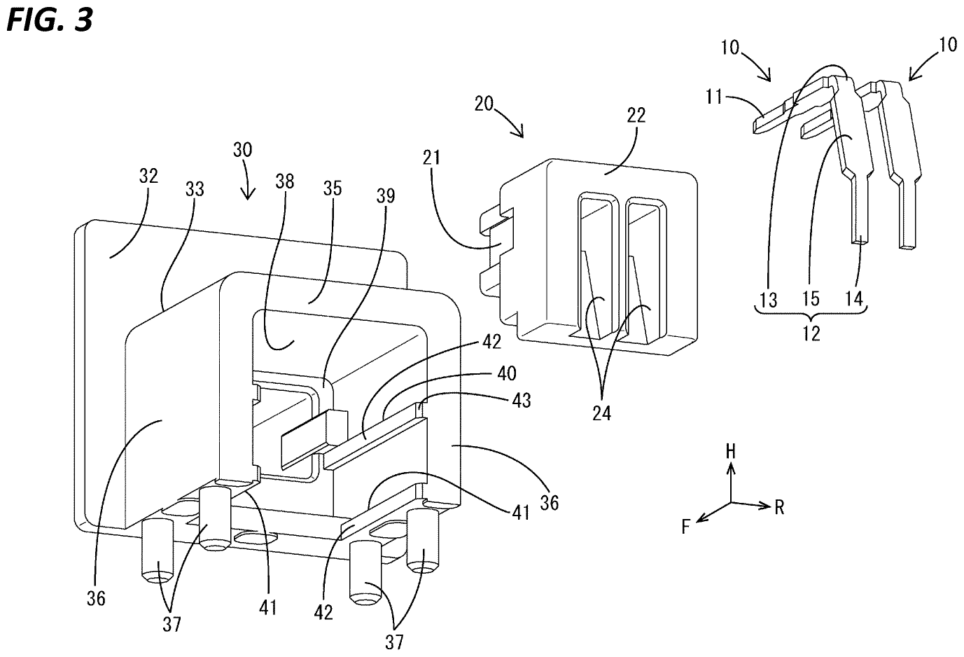

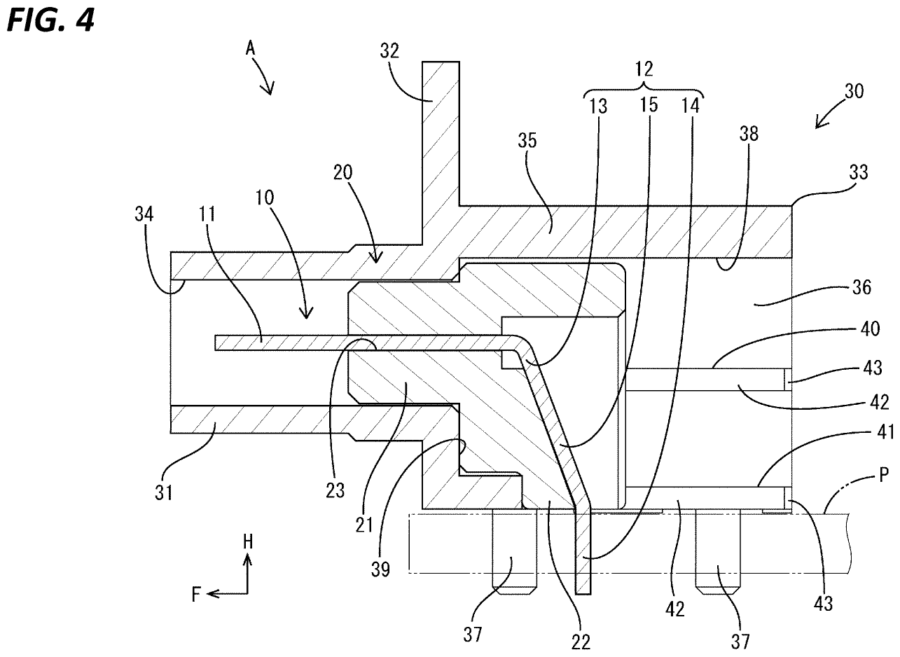

The board connector A of this embodiment is a connector having a shielding function and to be mounted on a circuit board P. As shown in FIG. 3, the board connector A is configured by assembling inner conductors 10, a dielectric 20 and an outer conductor 30. The inner conductor 10 is a single component formed by bending an elongated plate material made of metal. As shown in FIGS. 3 and 4, the inner conductor 10 includes a terminal connecting portion 11 extending in the front-rear direction and a board connecting portion 12 in the form of a cantilever obliquely extending to a lower rear side from the rear end of the terminal connecting portion 11. The board connecting portion 12 includes an upper end side narrow portion 13 connected to the terminal connecting portion 11, a lower end side narrow portion 14 to be fixed to the circuit board P and a wide portion 15 connecting the upper end side narrow portion 13 and the lower end side narrow portion 14. A width of the wide portion 15 is larger than those of the upper end side narrow portion 13 and the lower end side narrow portion 14.

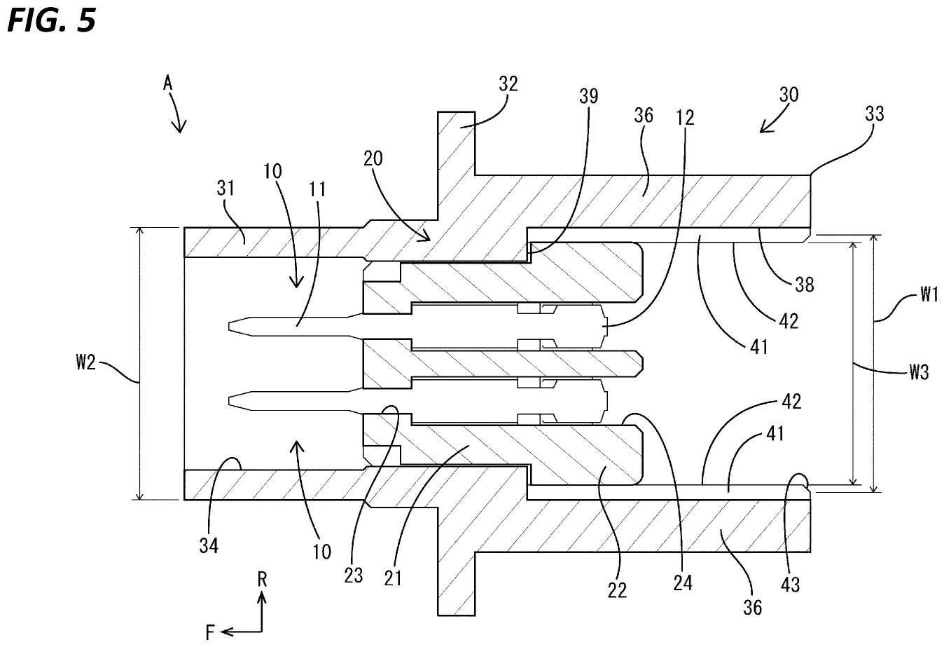

The dielectric 20 is a single component made of synthetic resin and including a front accommodating portion 21 and a rear accommodating portion 22. As shown in FIGS. 4 and 5, the front accommodating portion 21 is formed with a pair of left and right press-fit holes 23 penetrating through the front accommodating portion 21 in the front-rear direction. The rear accommodating portion 22 is a part projecting rearward from a rear end part of the front accommodating portion 21. A vertical dimension of the rear accommodating portion 22 is larger than that of the front accommodating portion 21. A width (lateral dimension) of the rear accommodating portion 22 is larger than that of the front accommodating portion 21. The rear accommodating portion 22 is formed with a pair of left and right accommodation grooves 24 open rearward and downward. The rear end of the press-fit hole 23 is open in an upper end part of the accommodation groove 24.

A pair of left and right inner conductors 10 are mounted in the dielectric 20. In mounting, the terminal connecting portion 11 is press-fit into the press-fit hole 23 from behind the dielectric 20. With the inner conductor 10 mounted in the dielectric 20, a front end part of the terminal connecting portion 11 projects forward from the front accommodating portion 21 and the board connecting portion 12 is accommodated in the accommodation groove 24. A lower end part of the board connecting portion 12 projects downward from the lower surface of the dielectric (rear accommodating portion 22).

The outer conductor 30 is a single component made of metal and formed by die casting. As shown in FIGS. 1, 2, 4 and 5, the outer conductor 30 includes a receptacle 31, a flange portion 32 and a gate-shaped portion 33. In a front view of the outer conductor 30, the receptacle 31 has a rectangular shape having long sides extending in the lateral direction. An accommodation space 34 for accommodating the front accommodating portion 21 of the dielectric 20 is formed inside the receptacle 31. The flange portion 32 is shaped to bulge in the vertical direction and the lateral direction from a rear end part of the outer peripheral surface of the receptacle 31.

The gate-shaped portion 33 is shaped to project rearward from the rear surface of the flange portion 32. The gate-shaped portion 33 includes an upper wall portion 35, a pair of side wall portions 36, a pair of upper ribs 40 and a pair of lower ribs 41. The upper wall portion 35 horizontally extends rearward from the rear surface of the flange portion 32 with a thickness direction oriented in the vertical direction. The both left and right side wall portions 36 extend rearward from the rear surface of the flange portion 32 with a thickness direction oriented in the lateral direction. The upper end edges of the both side wall portions 36 are connected at a right angle to both left and right side edges of the upper wall portion 35. A pair of leg portions 37 spaced apart in the front-rear direction are formed on the lower end surface of each of the side wall portions 36. The outer conductor 30 is conductively mounted on the circuit board P by fitting the leg portions 37 into fitting holes (not shown) of the circuit board P.

An open space 38 open behind and below the gate-shaped portion 33 is formed inside the gate-shaped portion 33. A vertical dimension of the open space 38 is larger than that of the accommodation space 34. A width of the open space 38 is larger than that of the accommodation space 34. As shown in FIGS. 3 to 5, a rectangular stopper 30 surrounding an opening of the accommodation space 34 over an entire periphery is formed in the back end surface (front end surface) of the open space 38 by dimensional differences between the open space 38 and the accommodation space 34.

The dielectric 20 is mounted in the outer conductor 30. In mounting, the dielectric 20 is inserted into the open space 38 from behind the outer conductor 30, the front accommodating portion 21 is fit into the accommodation space 34 and the rear accommodating portion 22 is arranged in the open space 38. By butting an outer peripheral edge part of the front surface of the rear accommodating portion 22 against the stopper 39, the dielectric 20 is positioned in the front-rear direction with respect to the outer conductor 30. With the dielectric 20 mounted in the outer conductor 30, the front end parts of the terminal connecting portions 11 are arranged in the receptacle 31 (in the accommodation space 34). The lower end parts of the board connecting portions 12 project downward from the lower surface of the gate-shaped portion 33.

A maximum facing interval W1 between the inner surfaces of the side wall portions 36 (maximum width of the open space 38) is equal to or slightly larger than a width W2 of the receptacle 31 (distance between both left and right outer side surfaces of the receptacle 31). Thus, when a multitude of outer conductors 30 are conveyed in a bagged state or a boxed state, the receptacle 31 may be fit into the open space 38. As a countermeasure against this, the pair of upper ribs 40 and the pair of lower ribs 41 are formed on the inner surfaces of the both left and right side wall portions 36, i.e. the facing inner side wall surfaces of the both side wall portions 36.

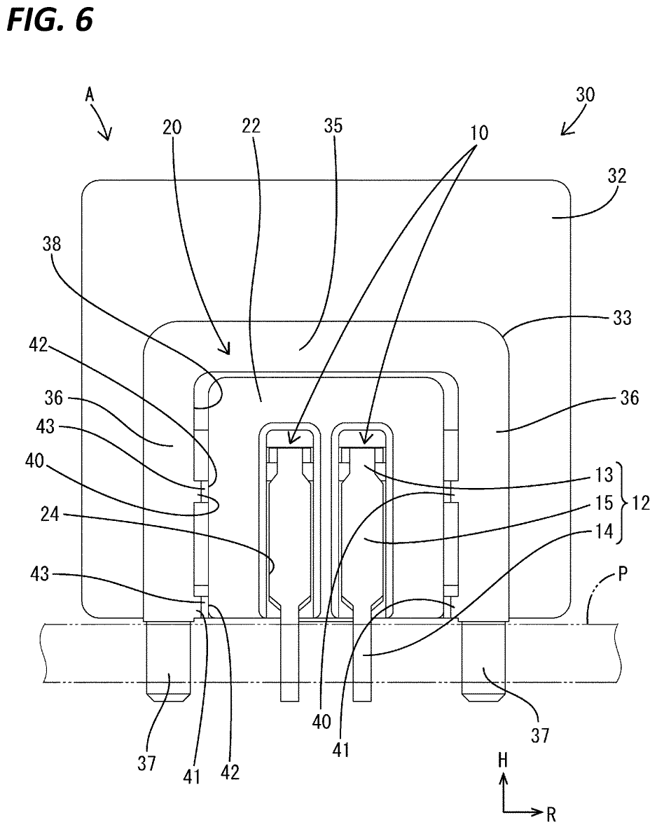

As shown in FIG. 6, in a back view of the gate-shaped portion 33, each rib 40, 41 has a rectangular shape. Each side wall portion 36 is formed with one upper rib 40 and one lower rib 41. These ribs 40, 41 extend straight in the front-rear direction. As shown in FIG. 5, a formation range of the ribs 40, 41 in the front-rear direction is a range from the front end (stopper 39) of the open space 38 to the rear end (gate-shaped portion 33) of the open space 38.

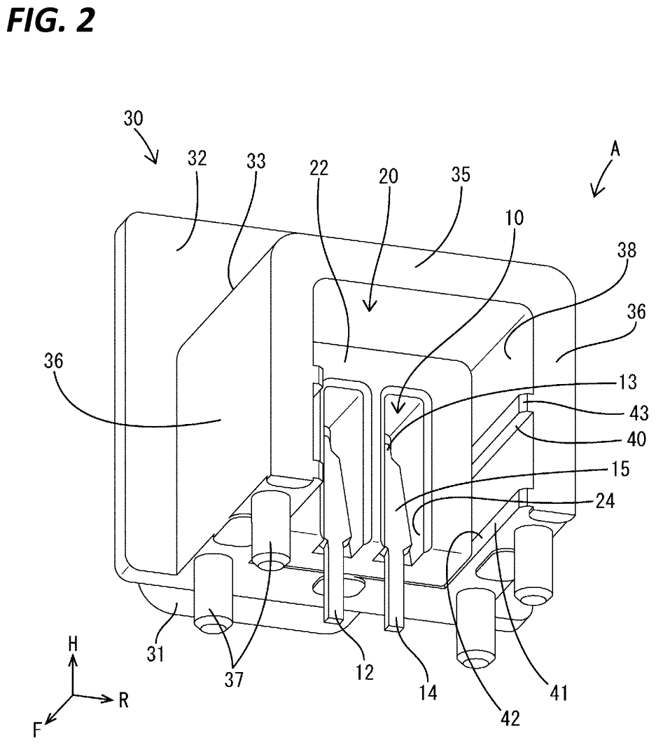

As shown in FIGS. 2 to 4, the upper ribs 40 are arranged in a central part of the open space 38 in a height direction. In other words, the upper ribs 40 are located within the formation range of the accommodation space 34 in the vertical direction. The lower ribs 41 are arranged below the upper ribs 40. The lower ribs 41 are located along lower end edge parts of the side wall portions 36 in a lower end part of the open space 38. The pair of upper ribs 40 are located to face each other in the lateral direction at the same height. The pair of lower ribs 41 are located to face each other in the lateral direction at the same height. The inner surfaces of the pair of upper ribs 40 facing each other and those of the pair of lower ribs 41 facing each other are defined as facing surfaces 42.

A facing interval between the facing surfaces 42 of the pair of upper ribs 40 and a facing interval between the facing surfaces 42 of the pair of lower ribs 41 are set to be equal. This facing interval is defined as a minimum facing interval W3 between the both left and right side wall portions 36. The minimum facing interval W3 is set to be smaller than the width W2 of the receptacle 31. This minimum facing interval W3 is set to be equal to or slightly larger than a width of the rear accommodating portion 22 of the dielectric 20 (distance between both left and right outer side surfaces of the rear accommodating portion 22).

A rear end part of the facing surface 42 of each rib 40, 41 is formed with a guide surface 43 inclined with respect to a length direction of the rib 40, 41 in a plan view of the outer conductor 30. The guide surfaces 43 facing each other in the lateral direction are inclined to widen the facing interval toward a rear side. If the position of the dielectric 20 deviates in the lateral direction with respect to the outer conductor 30 when the dielectric 20 is assembled with the outer conductor 30, the outer side surface of the front accommodating portion 21 and the outer side surface of the rear accommodating portion 22 slide in contact with the guide surfaces 43, whereby the position deviation is corrected. In this way, the front accommodating portion 21 is inserted into the accommodation space 34 without being caught by the stopper 39.

The board connector A of this embodiment is provided with the inner conductors 10 to be connected to the circuit board P, the dielectric 20 for accommodating the inner conductor 10 and the outer conductor 30 for surrounding the dielectric 20. The outer conductor 30 includes the receptacle 31 and the gate-shaped portion 33. The receptacle 31 surrounds the front end parts of the terminal connecting portions 11 of the inner conductors 10. The gate-shaped portion 33 is arranged over a range behind the inner conductors 10 and the dielectric 20. The gate-shaped portion 33 is so shaped that the rear surface and the lower surface facing the circuit board P are open. The pair of upper ribs 40 and the pair of lower ribs 41 are formed on the inner surfaces of the both left and right side wall portions 36 constituting the gate-shaped portion 33. The minimum facing interval W3 between the pair of side wall portions 36 including the upper and lower ribs 40, 41 is smaller than the width W2 of the receptacle 31.

According to this configuration, since the minimum facing interval W3 between the pair of side wall portions 36 including the upper and lower ribs 40, 41 is smaller than the width W2 of the receptacle 31, it can be suppressed that the receptacle 31 is fit into the gate-shaped portion 33. By forming the upper and lower ribs 40, 41, the maximum facing interval W1 between the pair of side wall portions 36 can be enlarged. In this way, a reduction in impedance is suppressed, wherefore impedance matching can be performed.

The accommodation space 34 for accommodating the dielectric 20 is formed in a region in front of the gate-shaped portion 33 in the outer conductor 30. The accommodation space 34 is open rearward. The upper and lower ribs 40, 41 are formed with the guide surfaces 43 for guiding the dielectric 20 in the process of inserting the dielectric 20 into the accommodation space 34. According to this configuration, workability in inserting the dielectric 20 into the accommodation space 34 is improved.

The board connecting portion 12 to be connected to the circuit board P, out of the inner conductor 10, is exposed while extending thin and long in the vertical direction in the accommodation groove 24 in the rear surface of the dielectric 20. In a back view of the outer conductor 30, the upper and lower ribs 40, 41 are arranged only at heights near the upper end side narrow portions 13 (upper end parts) and the lower end side narrow portions 14 (lower end parts) of the board connecting portions 12. According to this configuration, impedance mismatching due to the formation of the upper and lower ribs 40, 41 can be suppressed.

The board connecting portion 12 to be connected to the circuit board P, out of the inner conductor 10, is exposed while extending thin and long in the vertical direction in the accommodation groove 24 in the rear surface of the dielectric 20. The wide portion 15 having a larger width than the both upper and lower end parts (upper end side narrow portion 13, lower end side narrow portion 14) is formed in an intermediate region between the both upper and lower end parts (upper end side narrow portion 13, lower end side narrow portion 14) of the board connecting portion 12, out of the board connecting portion 12. The upper and lower ribs 40, 41 are arranged at heights different from the wide portions 15 in the vertical direction. According to this configuration, impedance mismatching due to the formation of the lower ribs 41 can be suppressed.

### Other Embodiments

The present invention is not limited to the above described and illustrated embodiment, but is represented by claims. The present invention includes all changes in the scope of claims and in the meaning and scope of equivalents and also includes the following embodiments.

The outer conductor is not limited to the one formed by die casting, but may be the one formed by forging or casting or may be the one formed by bending a metal plate material.

The ribs may not have the guide surfaces.

The ribs may be arranged at a height between the both upper and lower end parts of the board connecting portions.

The ribs may be arranged in a region above the upper ends of the board connecting portions.

The ribs may be arranged at the same height as the wide portions.

Only one, three or more ribs may be formed on one side wall portion.

The ribs may be formed on only one of the both left and right side wall portions.

The board connecting portion may not be formed with the wide portion.

### LIST OF REFERENCE NUMERALS

P . . . circuit board
W1 . . . maximum facing interval between side wall portions
W2 . . . width of receptacle
W3 . . . minimum facing interval between side wall portions
10 . . . inner conductor
11 . . . terminal connecting portion
12 . . . board connecting portion
13. . . . upper end side narrow portion (upper end part)
14 . . . lower end side narrow portion (lower end part)
15 . . . wide portion
20 . . . dielectric
21 . . . front accommodating portion
22 . . . rear accommodating portion
23 . . . press-fit hole
24 . . . accommodation groove
30 . . . outer conductor
31 . . . receptacle
32 . . . flange portion
33 . . . gate-shaped portion
34 . . . accommodation space
35 . . . upper wall portion
36 . . . side wall portion
37 . . . leg portion
38 . . . open space
39 . . . stopper
40 . . . upper rib (rib)
41 . . . lower rib (rib)
42 . . . facing surface
43 . . . guide surface

1. A board connector, comprising:
an inner conductor to be connected to a circuit board;
a dielectric for accommodating the inner conductor; and
an outer conductor for surrounding the dielectric,
the outer conductor including a receptacle for surrounding a front end part of the inner conductor and a gate-shaped portion to be arranged over a range behind the inner conductor and the dielectric,
the gate-shaped portion being such that a rear surface and a lower surface facing the circuit board are open,
a rib being formed on an inner surface of at least one of both left and right side wall portions constituting the gate-shaped portion,
a minimum facing interval between the pair of side wall portions including the rib being smaller than a width of the receptacle, and
a maximum facing interval between the inner surfaces of the pair of side wall portions being larger than the width of the receptacle.

2. The board connector of claim 1, wherein:
an accommodation space open rearward to accommodate the dielectric is formed in a region in front of the gate-shaped portion in the outer conductor, and
the rib is formed with a guide surface for guiding the dielectric in a process of inserting the dielectric into the accommodation space.

3. The board connector of claim 1, wherein:
a board connecting portion to be connected to the circuit board, out of the inner conductor, is exposed while extending thin and long in a vertical direction in a rear surface of the dielectric, and
the rib is arranged only at a height near an upper end part or a lower end part of the board connecting portion.

4. The board connector of claim 1, wherein:
a board connecting portion to be connected to the circuit board, out of the inner conductor, is exposed while extending thin and long in a vertical direction in a rear surface of the dielectric,
a wide portion having a larger width than the both upper and lower end parts is formed in an intermediate region between the both upper and lower end parts of the board connecting portion, out of the board connecting portion, and
the rib is arranged at a height different from the wide portion in the vertical direction.
